(19) United States
(12) Patent Application Publication
(10) Pub. No.: US 2011/0267179 A1
(43) Pub. Date: Nov. 3, 2011

(54) ROUTE GUIDANCE SYSTEM

(76) Inventor: Kieran Patterson, Lurgan (GB)

(21) Appl. No.: 13/128,450

(22) PCT Filed: Nov. 10, 2009
(86) PCT No.: PCT/EP09/08013

§ 371 Date: Jun. 16, 2011

(30) Foreign Application Priority Data
Nov. 11, 2008 (GB) 0820606.2

(51) Int. Cl. G08B 7/06

(52) U.S. Cl. 340/286.02

(57) ABSTRACT

A route guidance system for guiding occupants of an enclosed space to a location, such as an exit, said system comprising a network of interconnected nodes located at spaced locations throughout said enclosed space, at least some of said nodes being adapted to convey route guidance instruction to said occupants, each node comprising a control unit and a communication means enabling the control unit to communicate with the control unit of at least one adjacent node for passing information and/or instructions between adjacent nodes.

This application is a 35 U.S.C. §371 national phase filing of PCT/EP2009/008013 filed on Nov. 10, 2009, which claims priority to UK Patent Application 0820606.2 filed on Nov. 11, 2008, the disclosures of which are incorporated herein by reference in their entireties.

### BACKGROUND

This invention relates to a route guidance system for guiding occupants of an enclosed space, such as a building and in particular to an intelligent route guidance and effective evacuation system for guiding occupants to a safe exit in an emergency.

In recent years, natural disasters and terrorist threats, coupled with a growing awareness of public safety, has highlighted the need for action to be taken in addressing the issue of mass evacuation of people from all enclosed spaces. Examples of this are only too frequent, in particular in light of the 9/11 tragedy, the Austrian fire tunnel disaster, the Mont Blanc road tunnel disaster, all of which have heightened the concerns of all countries with respect to measures to be taken in limiting the damage caused, and more importantly in saving lives.

Statistics show an ever growing demand on public transport, which is apparent when we look at the escalating number of people using the underground networks of various countries. For example, there are 3.5 million people travelling daily on the London Underground alone, 2 million people using the 722 miles of the New York subway and almost 6 million people commuting via the Paris Metro. With such vast numbers of people contained in a limited area of space, it is clearly recognised that while prevention is always the best outcome, minimising the potential destruction and devastation is also as important.

In August 2003, New York was placed in the ever more occurring situation of a blackout, when the national grid failed. Tens of thousands of people fled into the streets after a power outrage turned out the lights and shut down air conditioning across the city. The fire department stated that it was nearly overwhelmed by phone calls reporting people trapped in elevators and subways. It took almost two and a half hours for people to evacuate from the subway to safety.

It is also desirable to provide systems for guiding a person through a building to a point of interest or an exit and for the general control of the flow of occupants in a building, to avoid congestion and or to assist persons in locating a desired room or object, as well as for guiding evacuation of a building in an emergency.

### SUMMARY

The present disclosure has therefore been developed with a view to mitigating the above mentioned problems.

According to the present disclosure there is provided a route guidance system for guiding occupants of an enclosed space to a location, such as an exit, said system comprising a network of interconnected nodes located at spaced locations throughout said enclosed space, at least some of said nodes being adapted to convey route guidance instruction to said occupants, each node comprising a control unit and a communication means enabling the control unit to communicate with the control unit of at least one adjacent node for passing information and/or instructions between adjacent nodes.

In an exemplary embodiment, the control unit of each node is programmed to control the operation of the node as a function of information and/or instructions received from one or more adjacent nodes and/or sensors and to communicate information and/or instructions to one or more further nodes in response to said information and/or instructions received.

In an exemplary embodiment, the control unit comprises a digital data processing unit or microcontroller.

In an exemplary embodiment, the communication means comprises a wireless communication means. Alternatively, or additionally, at least some of the nodes may be hardwired together.

In an exemplary embodiment, each node is provided with a unique identifier, such as a numeric identifier or address. Said unique identifier may be communicated to other nodes along with information/instructions to enable identification of each node of the system.

One of the nodes may be designated a leader or dominant node such that the leader node can determine the operation of all remaining nodes. The nodes may be designated in a hierarchy such that one node will take control of the nodes, becoming the leader node, should the existing leader node become disabled or damaged.

The route guidance instruction may be provided to the occupants by audible and/or visual display means.

In an exemplary embodiment, at least some of said nodes are provided with illumination means controllable by the control means to provide information and/or directional guidance, or simply illumination, to the occupants of the enclosed space.

One or more of said nodes may be provided with illumination means for guiding occupants to an exit and/or warning occupants that an adjacent exit is not useable.

One or more of the nodes may comprise at least one illumination device, wherein the at least illumination device is operable to adopt a selected one of at least two illuminated states depending on in accordance with instructions from the control unit as a function of instructions/information received by the control unit from other nodes and/or from one or more sensors.

In an exemplary embodiment, at least two of said illuminated states involve the display of a respective symbol, text message or illumination pattern. The symbol or illumination pattern may comprise a directional indictor or a warning indicator. At least two of said illuminated states may involve the emission of a respective illumination colour.

Said at least one illumination device may be associated with a set of stairs in order to illuminate the stairs when activated.

One or more of said nodes may comprise a floor tile, said at least one illumination device illuminating the tile to provide information, such as a direction indicator or arrow or a warning indicator.

One or more of said nodes may be wall mountable and/or be shaped and dimensioned to be fitted to or on a surface.

One or more of the nodes may comprise at least one light source and focusing means operable to focus the light into a beam projecting from the node. Preferably, one or more of the nodes includes means for projecting information, in use, within the beam(s) of light projecting from therefrom.

In an exemplary embodiment, the focusing means is operable to focus light from the at least one light source into a pair of beams, each beam projecting from outlets in a body of the node. Preferably, the outlets are arranged such that the pair of beams are directed in substantially opposite directions to one another.

The light source may comprise at least one LED, an array of LEDs, at least one laser device or laser cluster. Said at least one light source may comprise a projector, arranged to project information onto, in use, a surface adjacent the device. The projector may comprise a Holographic Laser Projector. The projector may be adapted to project a directional arrow onto the surface.

In an exemplary embodiment, at least one of said nodes is provided with a user interface to permit control and/or programming of the route guidance network. The user interface may comprise a suitable interface for a portable personal computer or programmable microcontroller.

In an exemplary embodiment, at least one of said nodes comprises a display, preferably located on a body of the node. Such display may display the status of some or all of the nodes of the system for monitoring the operation of the system. Such display may be combined with a user interface for providing manual control over the system.

One of more of the nodes may be provided with, or be associated, with one or more sensors for sensing environmental conditions, such as temperature and visibility/smoke, or traffic/movement of the occupants within the enclosed space, the control unit of such one or more nodes providing information to adjacent nodes based upon input from said one or more sensors. Said one or more sensors may comprise one or more of a heat sensor and/or a smoke sensor and/or an auditory sensor and/or a light sensor, the light sensor operable to generate a signal on detection of a reduced light level.

One or more of the nodes may be provided with a proximity sensor, enabling the node to determine crowding in the surrounding region and/or determining the movement of people in the region of the node. Said proximity sensor may be adapted to detect and recognise a unique identifier tag, such as an RFID tag, associated with a person or object adjacent the node, such that the node can identify the presence of said tagged person or object adjacent said node. Such arrangement may enable the network of nodes to monitor the location of said tagged person or object within said enclosed space. Such tagged person or object may comprise an emergency worker, such as a fire fighter, enabling the system to monitor the location of such tagged person within the enclosed space. The identifier tag may also provide information concerning the status or health of a person to which the tag is atached, said information being received by the node to enable the condition of a tagged person to be determined by the system.

Each node, or groups of said nodes, may be provided with an independent power source.

### BRIEF DESCRIPTION OF THE DRAWINGS

An embodiment of the present disclosure will now be described, by way of example only, with reference to the accompanying drawings, in which:—

FIG. 1 is a perspective view of a first type of node of a route guidance and evacuation system according to an embodiment of the present disclosure, referred to as an “Exit Finder” node;

FIG. 2 is a perspective view of the Exit Finder node in a second mode of operation;

FIG. 3 is a perspective view of an “Exit Finder” node adjacent a stair case;

FIG. 4 is a perspective view of a second type of node of the system, referred to as a “Path-Finder” node;

FIG. 5 is a perspective view of the Path Finder node in a second mode of operation;

FIG. 6 is a perspective view of a further type of node of the system, referred to as a “Door Finder” node;

FIG. 7 is a perspective view of the Door Finder node in a second mode of operation;

FIG. 8 is a perspective view of a further type of node of the system, referred to as an “Information Point”;

FIG. 9 is a perspective view of an implementation of the route guidance and evacuation system in a corridor;

FIG. 10 is a detailed view of the corridor of FIG. 9;

FIG. 11 is a further detailed view of the corridor of FIG. 9;

FIG. 12 is a schematic view of a floor plan showing the route guidance and evacuation system in operation; and

FIG. 13 is a further schematic view of a floor plan showing the route guidance and evacuation system in operation.

### DETAILED DESCRIPTION

A route guidance and evacuation system in accordance with an embodiment of the present disclosure is fundamentally a network of individual nodes. Each individual node on its own may represent a novel device for alerting evacuees from a smoke-filled building. However the real innovation in this system is the way these individual components interact to provide a coordinated and intelligent route guidance network for implementing a strategy for safe and efficient evacuation of an enclosed space.

Each individual node in the system is provided with a control unit and a communication means enabling the control unit of the node to communicate with adjacent nodes, each node having a unique address so that it can be identified by other nodes in the system. Each node may also be provided with means for providing route guidance advice/warnings to occupants of the building, means for sensing environmental parameters from the node's surroundings, means for displaying information to users and/or means for receiving external control commands, as will be described below in more detail.

Individual nodes of the network may use light in a variety of ways to convey instructions about how best to escape the danger zone and how to avoid areas of congestion or other hazards in the process. These various implementations include projected images and messages onto floor areas, focussed light beams of red or green, illuminated panels, icons or strips at floor or waist height where they will be of most value to an escapee in a dark and smoke filled building, as will be described below in more detail.

An important aspect of the route guidance and evacuation system according to the present disclosure is that its intelligence to convey these instructions is distributed rather than centralised. This means that if part of the network is destroyed by the very cataclysmic event that triggers the evacuation, the remainder of the network is able to continue to operate and even accommodate the damage.

The control unit of each node comprises a data processing device that can be programmed to communicate with the rest of the system and control operation of the node and/or adjacent or other nodes to achieve an overall route guidance or escape strategy.

An advantage of the system may be the provision of wireless connectivity between the nodes of the network in order to minimise the likelihood of partial disruption. However, irrespective of the connection technology, the system provides for uniquely addressable nodes so that the navigation strategy may be correctly tailored to the circumstances that prevail during the fire event.

The intelligence with which the system is endowed is an embodiment of established rules for building evacuation that are followed by fire officers world-wide, such rules being programmed into the control unit of each node. These rules respond to the individual building layout therefore when the route guidance and evacuation system is commissioned it must be programmed with key infrastructure information. Nevertheless even at the time of the fire it is possible for a fire officer on site to manually over-ride the automatic navigation instructions if necessary.

The route guidance and evacuation system may comprise part of a primary fire alert system or may be a fully non-invasive adjunct to the primary fire alarm system providing enhanced escape information.

The system may have application completely out with that of providing escape instruction. Even when there is no fire to escape from the route guidance and evacuation system may be used to display advertising, provide night-lighting, or simply provide an interesting route guide for visitors. Accordingly its very familiarity should enhance its effectiveness in the event of a fire with its terrifying circumstances—in that those in need of escape instruction will be acquainted with following its guidance which would not always be the case with conventional primary fire alert beacons.

In an exemplary embodiment, the system is non-invasive in that it should not obscure or detract from the primary fire alarm alerts, nor should it make any electrical connection with the existing fire alarm system so that there is no risk that it might in any way impede the function of the primary fire alarm.

### System Operational Control

As indicated above, the system operation is based on a set of fire-industry established rules for directing escape traffic governed by the infrastructure of the building in question. Preferably this intelligence will be programmed into each and every node of the network so that in the event of any partial disruption there is zero risk that the remaining network is left without operational control.

Although in this concept each node would then be capable of assuming control of the escape strategy, to avoid any conflicts only one node will be designated ‘leader’ at any time and the order of succession in the event of the ‘leader’ becoming disabled will be strictly programmed.

The system will be programmed and controlled in such a way as to achieve the following minimum set of objectives:
a) to ensure that every escapee can see clearly the route to their nearest stairwell
b) to ensure that in the event of overcrowding on a given stairwell, escapees will be directed to an alternate stairwell—even if it is not their nearest—on the basis that safety takes precedence over distance
c) Illustration of the escape route will be by pulsing green arrow symbols, or by illuminated green beams of focused light, or by projected messages on the floor
d) Warning of danger and of the need to divert will be by flashing red cross symbols, or
by intersecting red beams of focussed light, or by projected messages on the floor
e) Knowledge of the extent of crowding will be obtained by a combination of traffic flow monitoring (counting escapees past a given point by interrupted beam sensors or by floor mat sensors) and crowd plethysmography (estimating the number of escapees in a given space) by proximity sensors.
f) Knowledge of the extent of the influence of smoke or heat in a given space will be obtained by dedicated smoke detectors or temperature monitors or ambient light sensors.
g) Knowledge of the building layout and infrastructure will be programmed into the system at the time of commissioning. This knowledge will be automatically transferred to every intelligent node on the network
h) Interaction with the network by a human operator will be by a dedicated node on the network—which in practise may simply be a laptop with a USB dongle—or alternatively may be a hand-held field-robust dedicated programming unit. In the event of a human operator connecting to the network, this node will have the option of instantly assuming ‘leadership’ over the network, either temporarily or permanently, either partially (over a limited set of nodes) or entirely (over the entire network)

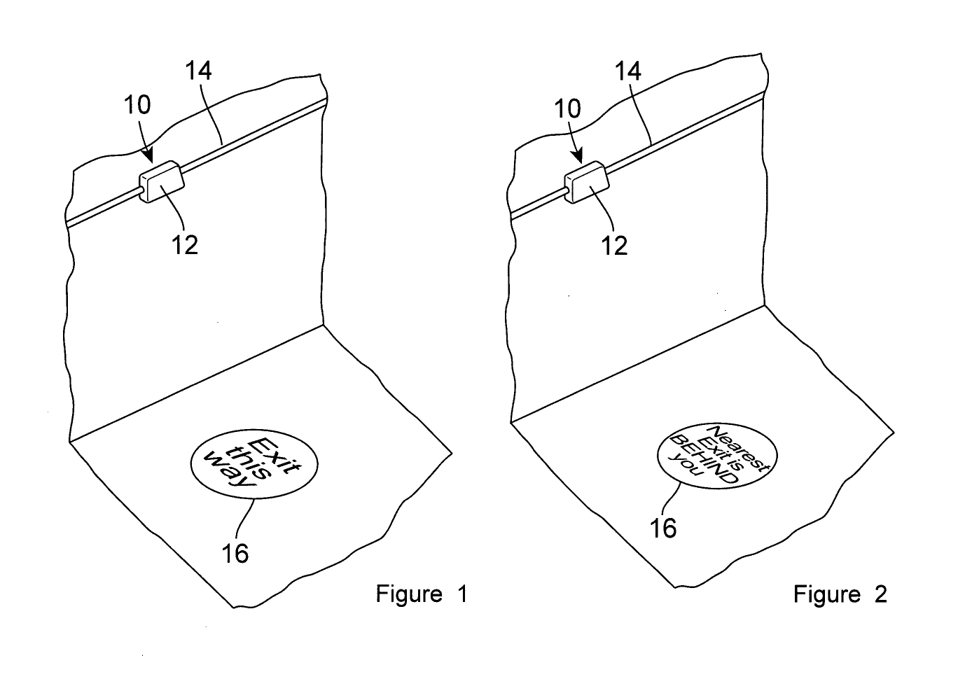

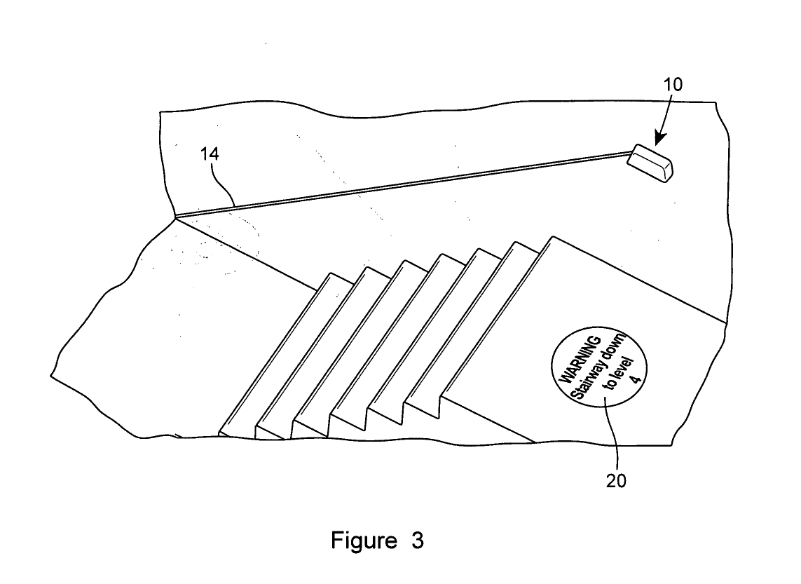

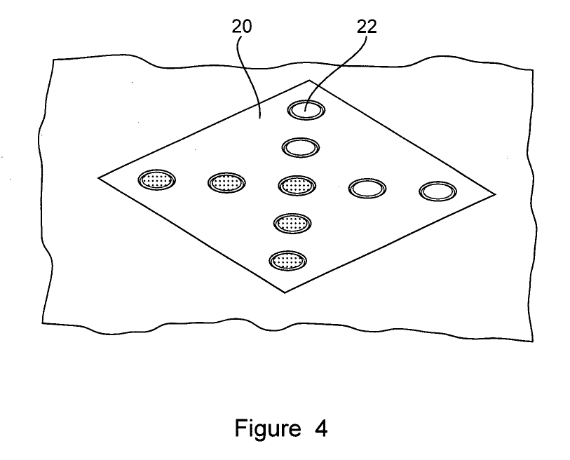

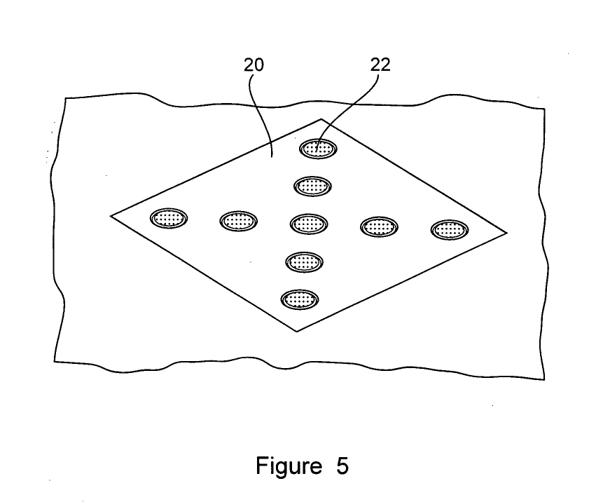

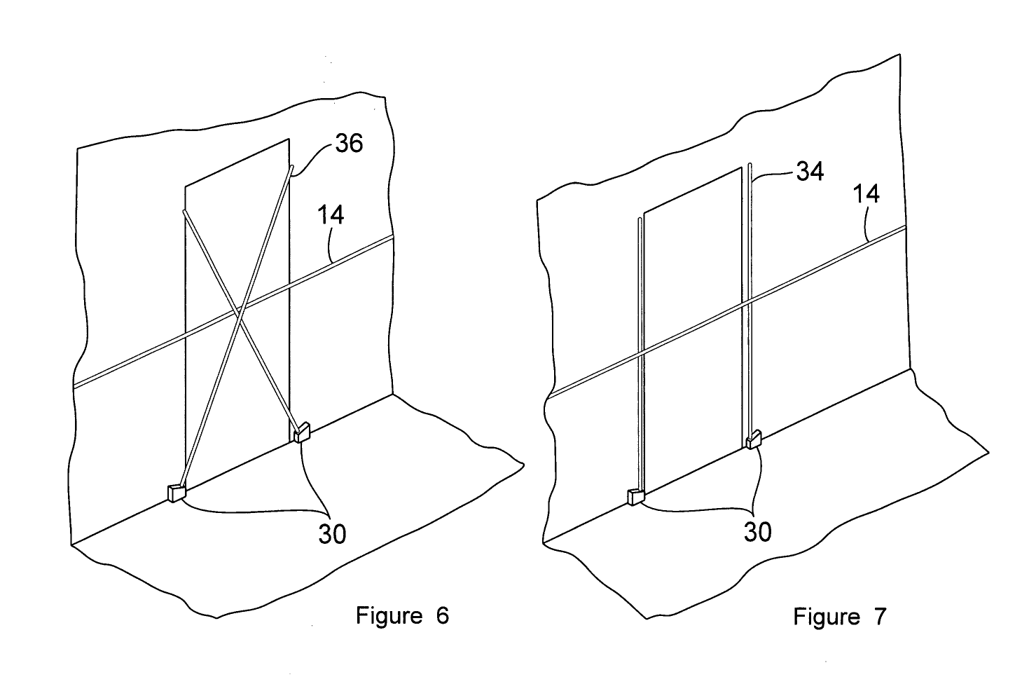

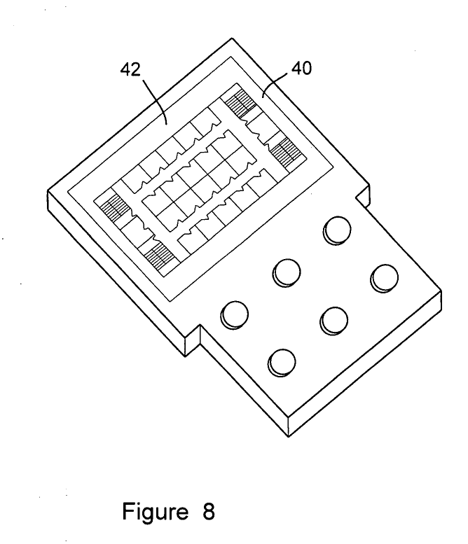

The following sub-systems may be equipped as nodes on the network. Each sub-system will become a node of the network by having a unique digital address and by being enabled to communicate with its neighbouring nodes either by a hard-wired connection or, more preferably, by a wireless connection.
1. Exit-Finder (see FIGS. 1 and 2). Each exit finder node 19 comprises a focused light projecting means, such as that disclosed in UK Patent Application No. 0804472.9, which is herein incorporated by reference in its entirety. This projecting means will be capable of projecting static colour images 16 of medium resolution over a 1.5 m-2 m distance, primarily onto the floor, as shown in the drawings. Such images can comprise textual instructions or images guiding a person to the nearest safe exit or can provide messages relevant to that particular location, such as local points of interest of the location of particular rooms or objects in the vicinity. The projecting means is controlled by the node's control unit as a function of the nodes programming and information received by the node from adjacent nodes and/or sensors. The Exit Finder node 10 is additionally adapted to project two focussed beams of green light 14 horizontally from either side of its enclosure 12. This is best envisaged in a long corridor where a number of exit-finder nodes 10 are fitted along the length of the corridor on one side on a spacing of 20 m apart. The resulting information display may be a series of projected images 16 on the floor spaced 20 m apart and a continuous beam of green focussed light 14 linking the nodes 10 together as each node 10 projects its beams of green light 14 towards each of its neighbouring nodes. Alternatively the Exit Finder nodes may comprise display means mounted on a surface, such as on the floor, for example in the form of a floor tile, having an array of tricolour LEDs that forms a robust dot-matrix display capable of displaying full colour animated or still images.
2. An modified version of the Exit Finder node may be used at the top of bottom of a stairway, as shown in FIG. 3, whereby the focussed beam of light 14 may be aimed to extend substantially parallel to the stairway and the information projected onto the floor can relate to the destination of the stairway and/or whether or not the stair way is safe to use.
3. Path-finder (see FIGS. 4 and 5): This node comprises a floor tile 20 that is equipped with a fixed array of LEDs 22 whose light is diffused so that light hot-spots are not visible, and so that the diffuser patterns can present to the escapee any of the following—a green arrow symbol (in any direction) as shown in FIG. 4, a red diagonal cross, as shown in FIG. 5, or a blue version of either of these symbols. Such arrangement is disclosed in WO 2005/122102, which is hereby incorporated by reference in its entirety. Although less sophisticated than the exit-finder node, the path-finder node will have identical control and communications technology and control software as all other nodes. All path-finder nodes on a given escape route will be coordinated so that their directional arrows will flash in a manner as to create the illusion of a moving arrow in the correct direction in order to further enhance the effectiveness of the instruction.
4. Corridor finder (not shown): this node comprises a decorative architrave (of any suitable material) that is equipped with a number of miniature copies of the path-finder pattern along its length. These patterns will serve an identical function as the path-finder patterns and will be controlled in an identical manner but will be distinctively an indication of the wall of an enclosed space and therefore a direct route to a door.
5. Door finder (see FIGS. 6 and 7): this is an important node in the network because it serves to instruct escapees if a given door is safe to pass through (“safe” in terms of either smoke or heat or crowdedness). This node may use similar technology to the focussed beams of light employed in the exit-finder module and can either project vertical green beams of light 34 as columns up the door-posts to indicate a safe exit, or can project intersecting red beams of light 36 across the doorway as a diagonal cross to indicate an unsafe route, said light beams being projected from a pair of projecting means 30 located on either side of the doorway at floor level. The importance of beams of light is that in a smoky environment they will be visible even if the door is open due to scattering from the particles of smoke. Alternatively this node may utilise elongate illumination means mounted on either side of the given door, for example embedded in a decorative architrave, the control unit of the associated node being adapted to selectively illuminate the illumination means in a first colour, such as green, if the door is safe to use, and in a second colour, such as red, if the door is not safe to use, for example if the control unit of the node determines that there is a fire or other hazard on the other side of the door, by means of an associated sensor, such as a heat sensor, or based upon a communication received from an adjacent node. Similar nodes having strip like illumination devices having two illuminated states may be mounted in the underside of hand rails to provide coloured downlighting providing illumination of a stairway or passage while at the same time indicating whether or not such stairway of passage is safe to use.
6. The control unit of this node may be provided with temperature sensors on either side of the door to enable it to determine whether or not the door is safe to use. Such information will be communicated to other nodes so that the overall escape strategy of the system can be modified accordingly.
7. Smart-box (not shown): this node primarily allows a human operator to join the network and assume control if necessary. In its simplest form it is a laptop computer with a USB dongle that is designed to mimic the function of a node on the network and that can transmit and receive data and instructions to and from the network. In a more sophisticated implementation it is a robust dedicated programming unit with network functionality built-in that can withstand the aggressive environment of the danger-zone.
8. Stair-finder (not shown): this node has less navigation functionality and is much more of a fixed stand-alone safety device. It provides illumination of stair treads by means of lines of LEDs whose light is diffused so that light hot-spots are not visible in exactly the same technology as used for the path-finder tile above. Such arrangement is disclosed in previously incorporated UK Patent Application No. 0804472.9. In many applications the stair-finder function will be switched on at all times whether there is a fire or not because it reduces the risk of people falling by missing a stair. For this reason this sub-system may not actually be a node on the network and may simply function independently—however it can have the option of being a fully integrated node like the others described above. It is envisaged that similar elongate illumination device may be provided on the corners of walls to illuminate the ends of corridors.
9. Information point (see FIG. 8): the overall system will only function effectively if it is provided with adequate and current data about people movements and fire or smoke penetration. This node 40 provides a user display 45 showing the status of a number of nodes will be equipped with some or all of at least the following plug-in functions:
   a. Smoke detection—either optical or ultrasonic using conventional technology
   b. Temperature detection—using pre-calibrated thermistor sensors
   c. Ambient light detection—using simple redundant light dependent resistor technology or photodiode technology as a back-up check on the smoke detection.
   d. Count detection—using a reflected beam of light or a floor mat to count (estimate) the number of escapees passing a given point
   e. Number detection—using a proximity sensor such as a conventional PIR device to estimate the number of people within a given space

The route guidance and evacuation system may stand alone if necessary. However, it may function more effectively if it is integrated with an existing fire alarm system. In order to eliminate any risk of interfering with the existing fire alarm system (which is the primary alarm system) the system may use only one input from the fire alarm system—namely an alarm/no-alarm signal.

Preferably this signal will be available as an output line that can be connected in a “volt-free” connection into the system. (volt-free means in this context that the system draws negligible current from the signal line and puts no voltage onto the signal line).

If this signal is not available as a predefined output line then the system may take its input by an acoustic coupling to the fire alarm audible siren by means of an acoustic sensor tuned to the specific sound of the Fire Alarm bell.

This option allows for easy retro-fit into buildings with existing fire alarm technology and ensures that the system does not interfere in any way with the existing approved system.

Alternatively the system may receive electronic signals directly from the existing fire alarm panel and can therefore offer more intelligent triggering. This option is best suited to new-build installations and requires formal coordination with the fire-alarm supplier.

Typical Corridor Installation

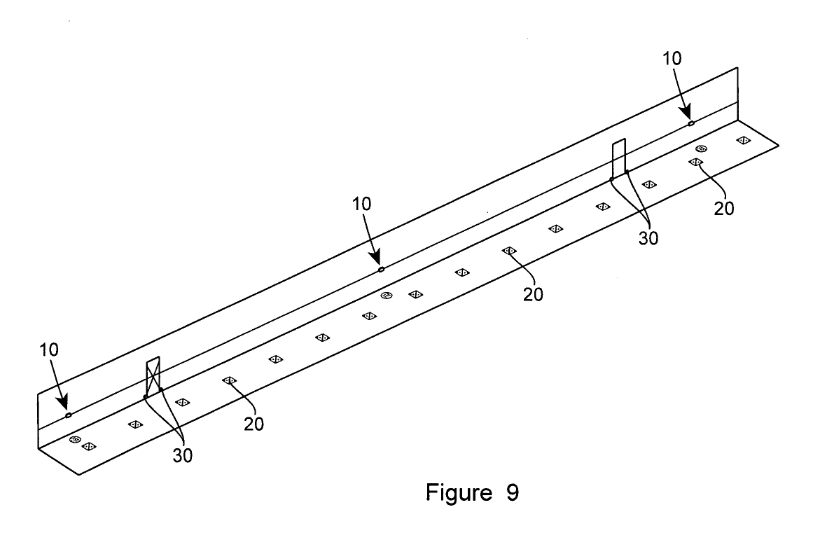

FIG. 9 illustrates a model corridor installation of the main nodes of the system—namely Door Finder nodes 30 adjacent each door way, Path Finder nodes 20 in the floor of the corridor, and Exit Finder nodes 10 at spaced locations on the walls of the corridor (or in the floor in the case of floor mounted display devices).

As discussed above, the route guidance and evacuation system according to the present disclosure is a network of distributed intelligence that shares full knowledge of the most suitable escape route with all nodes simultaneously by communication between the control units of the nodes of the system.

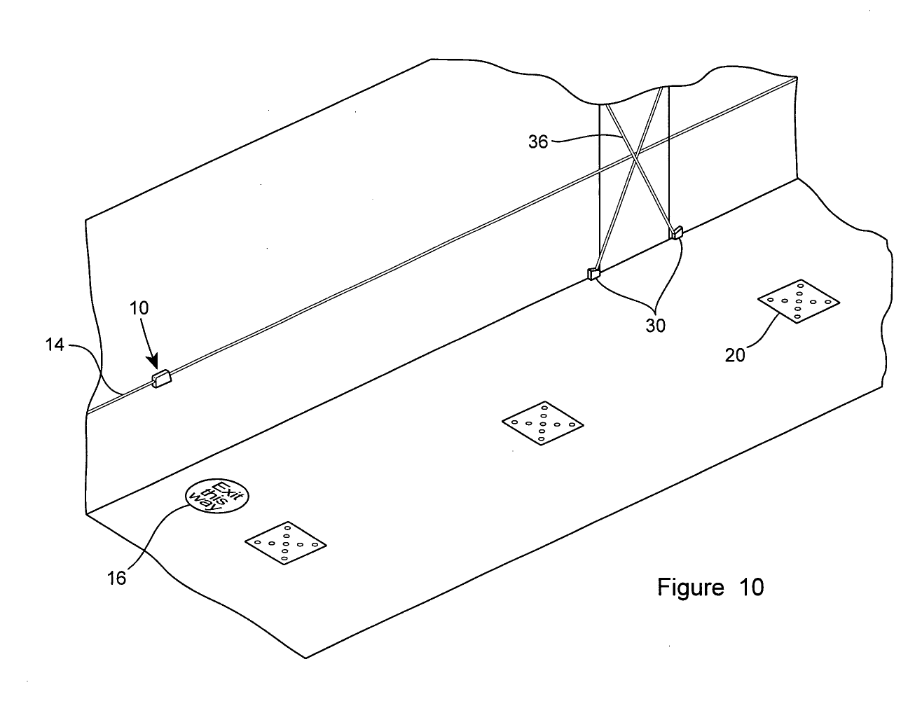

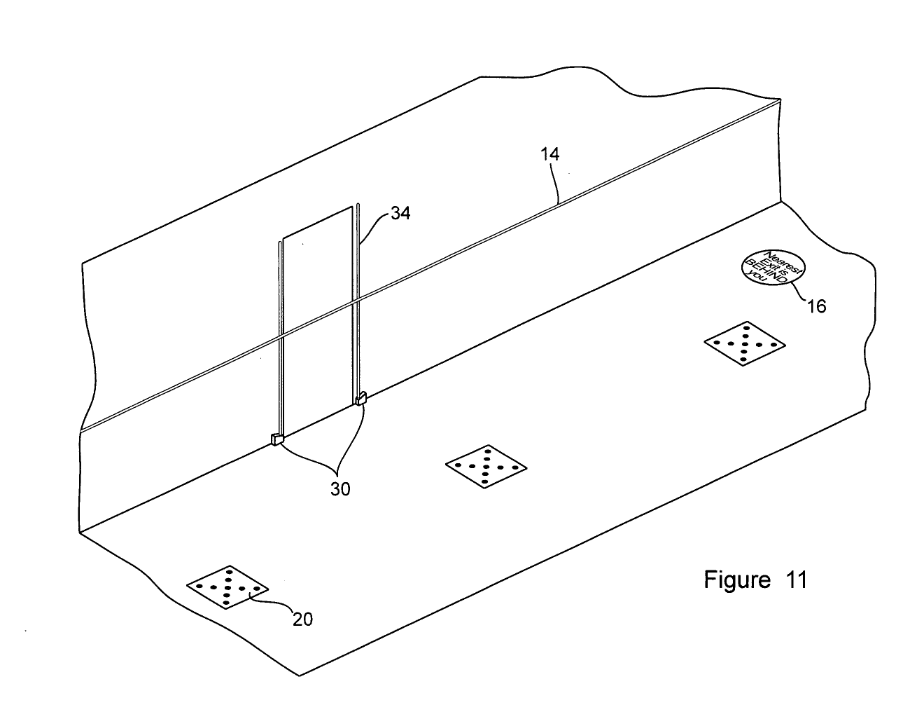

As shown in FIG. 10, if a Door Finder node 30 determines that the best escape route does not lie on the far side of the door then it presents a red cross of light beams across the doorway.

If, on the other hand, a Door Finder node 30 determines that the best escape route lies through the associated doorway, then it presents parallel green beams of light along the doorposts, as shown in FIG. 11.

The Exit Finder nodes 10 may be adapted to project horizontal green beams out either side to a distance of 10 m to provide navigation cues. They also provide projected images onto the floor, providing fully programmable, full colour images which can be updated dynamically as situations change. The projected images can offer specific, up to date navigational information to avoid confusion.

The Path Finder nodes comprise simple floor tiles (or alternatively sections of skirting board) with a versatile array of LEDs capable of indicating direction in any orientation or of indicating danger or warning by a red “X”.

One important feature of the Path Finder nodes is that the LEDs may be arranged so that the node can provide a different image depending on the user perspective. This means that an evacuee who is walking towards danger may see a red “X” from any given floor tile whereas an evacuee who is walking away from that danger towards the first evacuee will see a green arrow from the same tile or node.

These components function in an intelligent coordinated fashion to provide navigational assistance to escape from the danger zone. FIG. 10 shows how these three components guide escapees past an unsuitable exit leading ultimately to the suitable exit door, as illustrated in FIG. 11, and then providing warning not to proceed any further down the corridor because it only leads to a cul-de-sac (see FIG. 11)

The importance of the Stair Finder nodes, affixed to the edges of the steps or provided as stair rods, is that they offer not merely navigational assistance, but can also provide important visual cues of the stair edges (or corridor edges) to assist people in the dangerous passage down a stairwell in poor visibility.

As shown in FIG. 3, an Exit Finder node 10 can provide warning of a stairway and advice of location.

### Distributed Navigational Intelligence

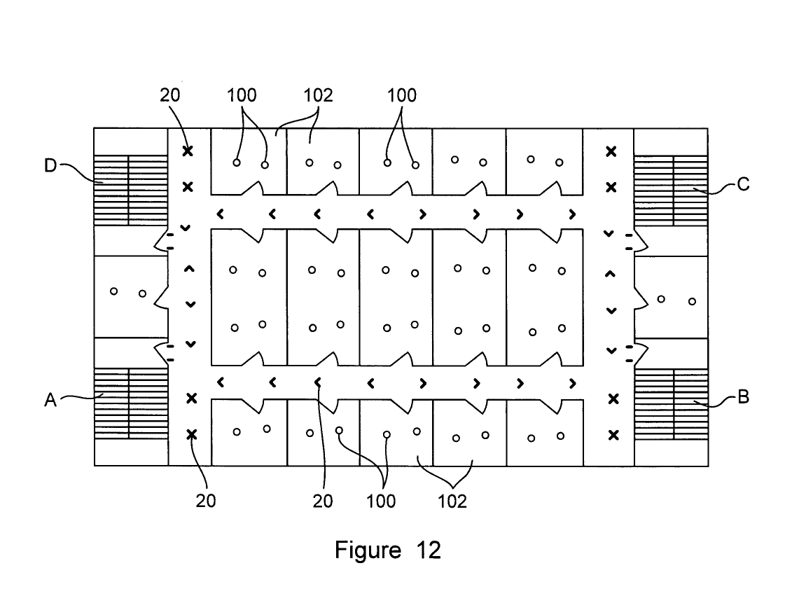

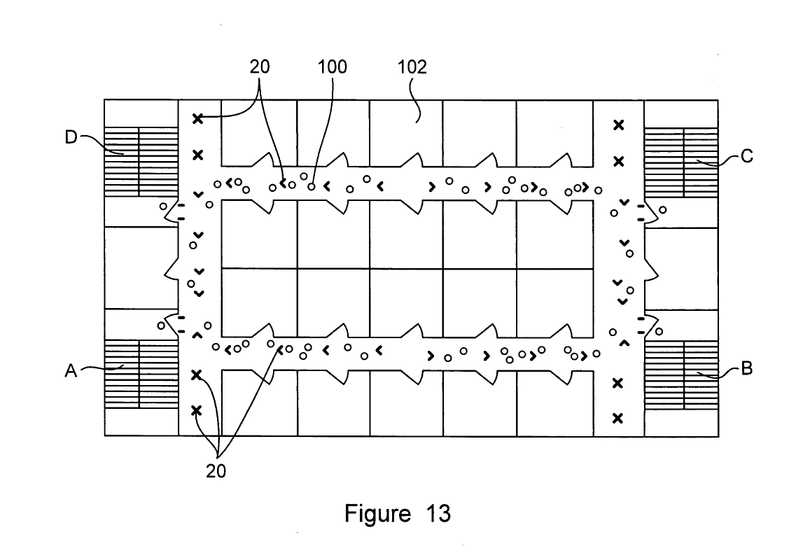

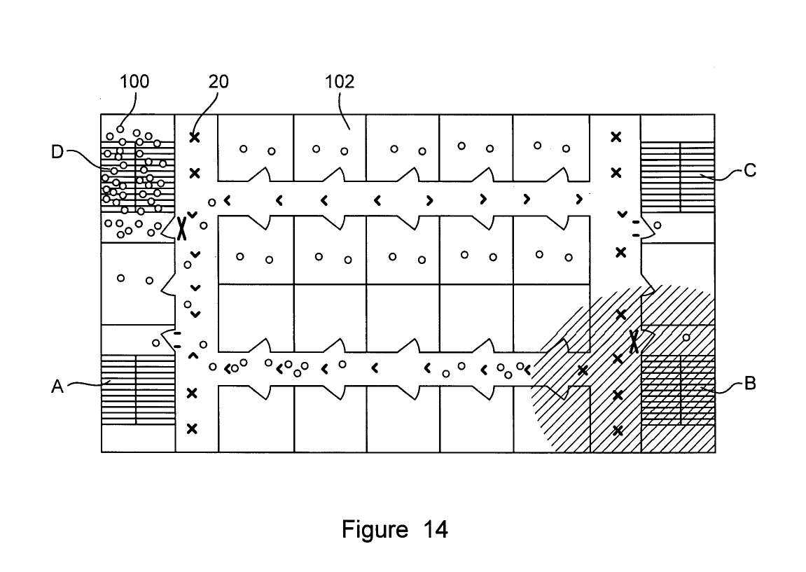

FIGS. 12 to 13 comprise highly stylised floor plans illustrating how the system functions as a distributed intelligent system.

Each node is equipped with identical processing power embedded in an on-board microprocessor and capable of communicating with all other nodes using either wireless or cable protocols.

Each node has a unique address and is routinely updated with the status of every other node on the network—so that effectively every node has the capability of being a master controller.

At any time only one node is designated as master controller, however every other node has capability to deputise if necessary and a hierarchy of succession is embedded in the operating protocol.

This provides for a disaster-proof protocol in that it is impossible for a disaster to disable the control of the exit navigation.

As illustrated in FIG. 12, the dark shaded dots 100 represent people who need to escape from the rooms 102 of a building. Initially there are no obstacles to any of the four optional stairways A,B,C,D so the navigational nodes of the system, in particular the floor mounted Path Finder nodes 20, each offer guidance simply to the nearest stairwell, as shown in FIG. 13.

However in the event of either (a) an overcrowded stairwell (region D in FIG. 14) or (b) a dangerously hot stairwell (region B in FIG. 14), the navigational components respond dynamically and change their configuration in order to re-route people away from their “nearest” stairwell in favour of the “nearest safe” stairwell. Such are only two examples used for illustration and other circumstances may exist that would cause the system to adapt its escape strategy.

Information about hazards in the environment is provided by a variety of sensor nodes that monitor variables such as traffic, temperature, smoke, connectivity, visibility and other important variables.

Each node may be provided with a reader for reading a unique identifier tag associated with a person or object coming into the promximity of the node, whereby the system may provide information regarding the location of such tagged person or object within building or other space within which the nodes are located. Such identifier tag may comprise an RFID tag or similar passive or active transponder device. Such identifier tag may also be adapted to provide information on the status or health of a person to which the tag is attached. Emergency workers, in particular fire fighters, may be provided with a unique identifier tag such that the location of each fire fighter within the building may be determined by the network or nodes and, optionally, the condition of each fire fighter may be determined, allowing injured fire fighters to be pin pointed and rescued from a building and also enabling the system to modify the evacuation strategy for guiding occupants from the building to clear areas where fire fighters require access and/or to guide fire fighters within the building or other enclosed space.

### Fire Chief Programmable Over-Ride

Although the system is equipped with fully automatic response protocol it is essential to permit an experienced fire officer on-the-scene to over-ride the automatic mode based on his/her superior understanding of the situation.

Accordingly the network protocol allows the designation of a hand-held or wall mounted human interface unit as the master controller for the network.

This is important for configuration of the network at the time of commissioning—however it is of critical importance in allowing experienced human intervention in the event of a real evacuation crisis. A human interface node gives visibility of all network nodes, providing their status and the status of all environmental variables—and permits human intervention to alter the escape route if necessary. Such interface may also provide information regarding the location of persons, in particular tagged persons, within the building or enclosed space within which the system in installed.

The disclosure is not limited to the embodiment(s) described herein but can be amended or modified without departing from the scope of the present disclosure.

1. A route guidance system for guiding occupants of an enclosed space to a location, such as an exit, said system comprising:
a network of interconnected nodes located at spaced locations throughout said enclosed space,
at least some of said nodes being adapted to convey route guidance instruction to said occupants,
each node comprising
a control unit and
a communication means enabling the control unit to communicate with the control unit of at least one adjacent node for passing information and/or instructions between adjacent nodes.

2. The system of claim 1, wherein said control unit of each node is programmed to control the operation of the node as a function of information and/or instructions received from one or more adjacent nodes and/or sensors and to communicate information and/or instructions to one or more further nodes in response to said information and/or instructions received.

3. The system of claim 1, wherein said control unit comprises a digital data processing unit or microcontroller.

4. The system of claim 1, wherein said communication means comprises a wireless communication means.

5. The system of claim 1, wherein at least some of the nodes may be hardwired together.

6. The system of claim 1, wherein each node is provided with a unique identifier, such as a numeric identifier or address.

7. The system of claim 6, wherein said unique identifier may be communicated to other nodes along with information/instructions to enable identification of each node of the system.

8. The system of claim 7, wherein one of the nodes is designated a leader or dominant node such that the leader node can determine the operation of all remaining nodes.

9. The system of claim 8, wherein the nodes are designated in a hierarchy such that one node will take control of the nodes, becoming the leader node, should the existing leader node become disabled or damaged.

10. The system of claim 1, wherein said route guidance instruction may be provided to the occupants by audible and/or visual display means.

11. The system of claim 1, wherein at least some of said nodes are provided with illumination means controllable by the control means to provide information and/or directional guidance, or simply illumination, to the occupants of the enclosed space.

12. The system of claim 1, wherein one or more of said nodes is provided with illumination means for guiding occupants to an exit and/or warning occupants that an adjacent exit is not useable.

13. The system of claim 1, wherein one or more of the nodes comprises at least one illumination device, wherein the at least illumination device is operable to adopt a selected one of at least two illuminated states depending on in accordance with instructions from the control unit as a function of instructions/information received by the control unit from other nodes and/or from one or more sensors.

14. The system of claim 13, wherein at least two of said illuminated states involve the display of a respective symbol, text message or illumination pattern.

15. The system of claim 14, wherein the symbol or illumination pattern comprises a directional indictor or a warning indicator.

16. The system of claim 13, wherein at least two of said illuminated states involves the emission of a respective illumination colour.

17. The system of claim 13, wherein said at least one illumination device may be associated with a set of stairs in order to illuminate the stairs when activated.

18. The system of claim 13, wherein one or more of said nodes may comprise a floor tile, said at least one illumination device illuminating the tile to provide information, such as a direction indicator or arrow or a warning indicator.

19. The system of claim 1, wherein one or more of said nodes is wall mountable and/or is shaped and dimensioned to be fitted to or on a surface.

20. The system of claim 1, wherein one or more of the nodes comprises at least one light source and focusing means operable to focus the light into a beam projecting from the node.

21. The system of claim 20, wherein one or more of the nodes includes means for projecting information, in use, within the beam(s) of light projecting from therefrom.

22. The system of claim 20, wherein the focusing means is operable to focus light from the at least one light source into a pair of beams, each beam projecting from outlets in a body of the node.

23. The system of claim 22, wherein the outlets are arranged such that the pair of beams are directed in substantially opposite directions to one another.

24. The system of claim 20, wherein the light source comprises at least one LED, an array of LEDs, at least one laser device or a laser cluster.

25. The system of claim 20, wherein said at least one light source comprises a projector, arranged to project information onto, in use, a surface adjacent the device.

26. The system of claim 25, wherein the projector comprises a Holographic Laser Projector.

27. The system of claim 25, wherein the projector is adapted to project a directional arrow onto the surface.

28. The system of claim 1, wherein at least one of said nodes is provided with a user interface to permit control and/or programming of the route guidance network.

29. The system of claim 28, wherein the user interface comprises a suitable interface for a portable personal computer or programmable microcontroller.

30. The system of claim 1, wherein at least one of said nodes comprises a display located on a body of the node.

31. The system of claim 30, wherein such display displays the status of some or all of the nodes of the system for monitoring the operation of the system.

32. The system of claim 30, wherein such display is combined with a user interface for providing manual control over the system.

33. The system of claim 1, wherein one of more of the nodes is provided with or associated with one or more sensors for sensing environmental conditions, such as temperature and visibility/smoke, or traffic/movement of the occupants within the enclosed space, the control unit of such one or more nodes providing information to adjacent nodes based upon input from said one or more sensors.

34. The system of claim 33, wherein said one or more sensors comprises one or more of a heat sensor and/or a smoke sensor and/or an auditory sensor and/or a light sensor, the light sensor operable to generate a signal on detection of a reduced light level.

35. The system of claim 1, wherein one or more of the nodes is provided with a proximity sensor, enabling the node to determine crowding in the surrounding region and/or determining the movement of people in the region of the node.

36. The system of claim 35, wherein said proximity sensor is adapted to detect and recognise a unique identifier tag, such as an RFID tag, associated with a person or object adjacent the node, such that the node can identify the presence of said tagged person or object adjacent said node.

37. The system of claim 36, wherein said unique indentifier tag may also provide information concerning the status or health of a person to which the tag is atached, said information being received by the node to enable the condition of a tagged person to be determined by the system.

38. The system of claim 1, wherein each node, or groups of said nodes, is provided with an independent power source.
